(19) United States
(12) Patent Application Publication
(10) Pub. No.: US 2021/0191116 A1
(43) Pub. Date: Jun. 24, 2021

(54) HEAD-UP DISPLAY AND VEHICLE

(71) Applicant: BOE TECHNOLOGY GROUP CO., LTD., Beijing (CN)

(72) Inventors: Bingchuan SHI, Beijing (CN); Baoyin YANG, Beijing (CN)

(21) Appl. No.: 16/755,738

(22) PCT Filed: Feb. 22, 2019
(86) PCT No.: PCT/CN2019/075767

§ 371 Date: Apr. 13, 2020

(30) Foreign Application Priority Data
May 24, 2018 (CN) 201810511714.7

(51) Int. Cl. G02B 27/01; G02B 27/28; G02B 5/10; G02B 5/30

(52) U.S. Cl. CPC G02B 27/0101; G02B 27/283; B60K 35/00; G02B 5/3083; G02B 5/10

(57) ABSTRACT

A head-up display and a vehicle are disclosed. The head-up display includes an image generating device and an optical module. The optical module includes at least a first optical component, a second optical component, and a third optical component. The image generating device emits a first projection light to the first optical component. The second optical component receives the first projection light reflected or transmitted by the first optical component and changes a polarization direction of the first projection light to obtain a second projection light, and reflects the second projection light back to the first optical component. The third optical component receives the second projection light reflected or transmitted by the first optical component and changes a polarization direction of the second projection light to obtain a third projection light, and reflects the third projection light back to the first optical component.

### RELATED APPLICATIONS

The present application claims the benefit of Chinese Patent Application No. 201810511714.7, filed on May 24, 2018, the entire disclosures of which are incorporated herein by reference.

### TECHNICAL FIELD

The present disclosure relates to the field of image display, and in particular, to a head-up display and a vehicle.

### BACKGROUND

In order to increase comfort and safety in modern vehicles, more and more vehicles are equipped with head-up displays (HUD). The head-up display usually uses a reflective imaging system to image the driving information displayed on a small display screen (usually with a size of 1.8 inches or 3.1 inches) as a virtual image suspending above the bonnet. The vehicle head-up display technology can enable the driver to observe the driving assistance information acquired by the vehicle system without interrupting the driver's observation of the road conditions, thereby effectively improving the operating efficiency of the traffic system and ensuring driving safety.

### SUMMARY

In a first aspect, a head-up display is provided. The head-up display includes: an image generating device and an optical module. The optical module includes at least a first optical component, a second optical component, and a third optical component. The first optical component is on a light emitting side of the image generating device. The image generating device emits a first projection light to the first optical component, and the first projection light is linearly polarized light. The second optical component receives the first projection light reflected or transmitted by the first optical component and changes a polarization direction of the first projection light to obtain a second projection light, and reflects the second projection light back to the first optical component. The third optical component receives the second projection light reflected or transmitted by the first optical component and changes a polarization direction of the second projection light to obtain a third projection light, and reflects the third projection light back to the first optical component.

In one or more embodiments of the present disclosure, the first optical component includes a polarization beam splitting element, and the polarization beam splitting element selectively transmits or reflects two linearly polarized light whose polarization directions are perpendicular to each other in a plurality of optical paths.

In one or more embodiments of the present disclosure, the first projection light is P-polarized light, the second projection light is S-polarized light, and the third projection light is P-polarized light. The first optical component transmits the first projection light to the second optical component, reflects the second projection light to the third optical component, and transmits the third projection light.

In one or more embodiments of the present disclosure, the first projection light is S-polarized light, the second projection light is P-polarized light, and the third projection light is S-polarized light. The first optical component reflects the first projection light to the second optical component, transmits the second projection light to the third optical element, and reflects the third projection light.

In one or more embodiments of the present disclosure, the second optical component includes a first polarization conversion element and a first reflective element; and the third optical component includes a second polarization conversion element and a second reflective element.

In one or more embodiments of the present disclosure, at least one of the first reflective element and the second reflective element is a concave mirror.

In one or more embodiments of the present disclosure, one of the first reflective element and the second reflective element is a flat mirror.

In one or more embodiments of the present disclosure, the image generating device includes a first display element and a half-wave plate. The first display element emits linearly polarized light. The half-wave plate changes a polarization direction of the linearly polarized light emitted from the first display element to obtain the first projection light.

In one or more embodiments of the present disclosure, the image generating device includes a second display element and a polarizer. The second display element emits non-linearly polarized light. The polarizer converts the non-linearly polarized light emitted from the second display element into linearly polarized light to obtain the first projection light.

In one or more embodiments of the present disclosure, the first polarization conversion element and the second polarization conversion element are ¼ wave plates, respectively.

In one or more embodiments of the present disclosure, the optical module further includes a fourth optical component. The fourth optical component receives and reflects the third projection light.

In one or more embodiments of the present disclosure, the fourth optical component includes a windshield of a vehicle.

In a second aspect, a vehicle is disclosed. The vehicle includes the head-up display provided by the embodiments of the present disclosure.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings may be obtained according to these drawings under the premise of not paying out creative work.

FIG. 1 shows an exemplary structural block diagram of a head-up display according to an embodiment of the present disclosure;

FIG. 2 shows an exemplary structure diagram of a head-up display according to an embodiment of the present disclosure;

FIG. 3 shows an exemplary structure diagram of a head-up display according to another embodiment of the present disclosure;

FIG. 4 shows a schematic structure diagram of an image generating device according to an embodiment of the present disclosure; and

FIG. 5 shows a schematic structure diagram of an image generating device according to another embodiment of the present disclosure.

### DETAILED DESCRIPTION OF THE DISCLOSURE

In the following, the technical solutions in embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

In the description of the present disclosure, it should be noted that the terms “first”, “second”, and “third” are used for descriptive purposes only, and cannot be understood to indicate or imply relative importance.

It should be noted that, in the case of no conflict, the embodiments in the present disclosure and the features in the embodiments can be combined with each other. The disclosure will be described in detail below with reference to the drawings and in connection with the embodiments.

Vehicle head-up displays are developed towards augmented reality display with large viewing angles and long projection distances, which places higher requirements on the performance of optical systems. However, off-axis optical systems based on reflection imaging principle are constrained by basic principle of geometrical optics. As the viewing angle increases, the size of the mirror surface increases, and the volume also increases accordingly; in addition, the aberration of the off-axis systems will also increase, and the design will be further complicated, making it difficult to reduce the volume of the off-axis optical systems. In view of the above defects or deficiencies in the prior art, it is desired to provide a head-up display with high integration and small volume.

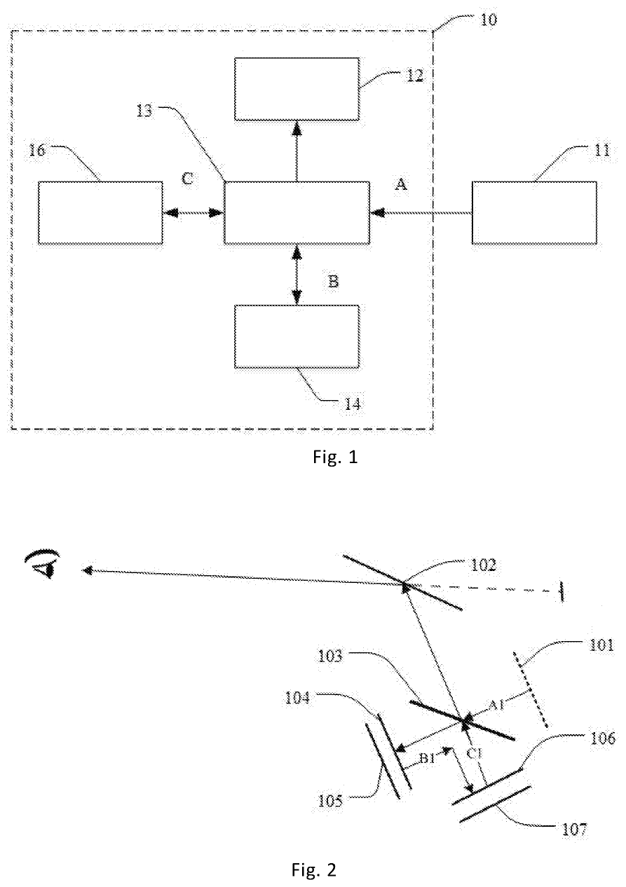

FIG. 1 shows an exemplary structural block diagram of a head-up display according to an embodiment of the present disclosure. As shown in FIG. 1, the head-up display includes an image generating device 11 and an optical module 10. The optical module 10 includes a first optical component 13, a second optical component 14, a third optical component 16, and a fourth optical component 12. The first optical component 13 is on a light emitting side of the image generating device 11. The image generating device 11 emits a first projection light A to the first optical component 13, and the first projection light A is linearly polarized light. The second optical component 14 receives the first projection light A reflected or transmitted by the first optical component 13 and changes a polarization direction of the first projection light A to obtain a second projection light B, and reflects the second projection light B back to the first optical component 13. The third optical component 16 receives the second projection light B reflected or transmitted by the first optical component 13 and changes a polarization direction of the second projection light B to obtain a third projection light C, and reflects the third projection light C back to the first optical component 13.

In the embodiment of the present disclosure, the first optical component 13 reflects or transmits the first projection light A, the second projection light B, and the third projection light C.

Optionally, the optical module 10 may further include the fourth optical component 12. The fourth optical component 12 receives and reflects the third projection light C. As shown in FIG. 1, the fourth optical component 12 receives and reflects the third projection light C, so that an observer can observe a virtual image. By using the mutual cooperation of the first optical component 13, the second optical component 14, and the third optical component 16, the first projection light A emitted by the image generating device 11 is transmitted and reflected by the first optical component 13 many times and then incident to the fourth optical component 12, so that an observer can observe a virtual image.

The above structure improves the integration degree of the head-up display and reduces the volume. According to the technical solution provided by the embodiment of the present disclosure, multiple propagations of the light beam is realized by the image generating device combined with the optical module, which solves the problem of large space occupied by the light path in the traditional head-up display and achieves the effect of reducing the volume.

In some embodiments, as shown in FIG. 2, the first optical component 13 may include a polarization beam splitting element 103, and the polarization beam splitting element 103 selectively transmits or reflects two linearly polarized light whose polarization directions are perpendicular to each other in a plurality of optical paths. In practical applications, the polarization beam splitting element 103 may be a polarization beam splitter. The polarization beam splitter may be formed by, for example, bonding two right-angle prisms. An inclined surface of one of the right-angle prisms is coated with a polarization beam splitting dielectric film, and the inclined surface forms an included angle with a first polarization conversion element 104 or a second polarization conversion element 106. Optionally, the included angle is 45 degrees.

FIG. 2 shows an exemplary structure diagram of a head-up display according to an embodiment of the present disclosure. The first projection light A1 is P-polarized light, the second projection light B1 is S-polarized light, and the third projection light C1 is P-polarized light. The first optical component including the polarization beam splitter 103 transmits the first projection light A1 to the second optical component including the first polarization conversion element 104 and a first reflective element 105. The first optical component further reflects the second projection light B1 to the third optical component including the second polarization conversion element 106 and a second reflective element 107, and transmits the third projection light C1 to the fourth optical component including a reflective element 102.

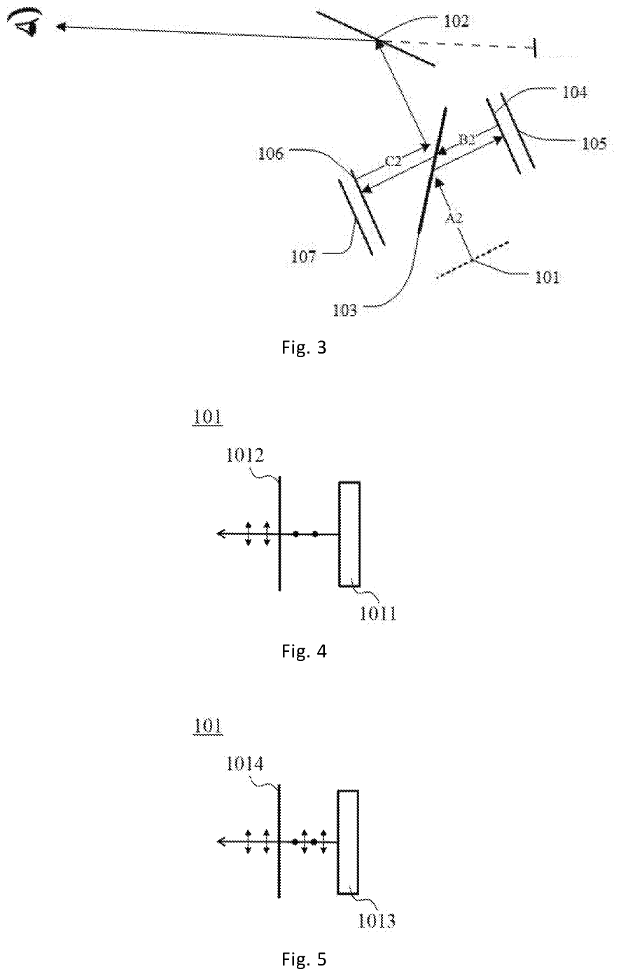

FIG. 3 shows an exemplary structure diagram of a head-up display according to another embodiment of the present disclosure. The first projection light A2 is S-polarized light, the second projection light B2 is P-polarized light, and the third projection light C2 is S-polarized light. The first optical component 13 reflects the first projection light A2 to the second optical component including a first polarization conversion element 104 and a first reflective element 105. The first optical component further transmits the second projection light B2 to the third optical element including a second polarization conversion element 106 and a second reflective element 107, and reflects the third projection light C2 to the fourth optical component including a reflective element 102.

In some embodiments, at least one of the first reflective element 105 and the second reflective element 107 is a concave mirror. In order to be able to adjust the focal power and obtain a relatively small system aberration, the first reflective element 105 or the second reflective element 107 may be a concave mirror. Of course, both the first reflective element 105 and the second reflective element 107 can be concave mirrors. Specifically, the concave mirror may adopt an aspherical surface or a spherical surface to meet the needs of imaging within a preset viewing angle. In addition, when the asymmetry of the reflective element 102 is obvious, the concave mirror may adopt a non-rotationally symmetric free curved surface to ensure the imaging quality.

In some embodiments, one of the first reflective element 105 and the second reflective element 107 is a flat mirror. When one reflective element is a concave mirror, the other reflective element may be a flat mirror.

FIG. 4 shows a schematic structure diagram of an image generating device according to an embodiment of the present disclosure. As shown in FIG. 4, in some embodiments, the image generating device 101 includes a first display element 1011 and a half-wave plate 1012. The first display element 1011 emits linearly polarized light. The half-wave plate 1012 changes a polarization direction of the linearly polarized light emitted from the first display element 1011 to obtain the first projection light. For example, when the first display element is a liquid crystal display device such as LCD or LCOS (Liquid Crystal on Silicon) that emits linearly polarized light, a display device that emits light with the same polarization direction as P-polarized light or S-polarized light may be used. If the polarization direction of the emitted polarized light is not the same as the P-polarized direction or the S-polarized direction, a half-wave plate, for example, can be added to the light emitting surface of the first display element 1011, the angle between the fast axis of the half-wave plate and the polarization direction can be adjusted, and the required P-polarized light or S-polarized light can thus be obtained.

FIG. 5 shows a schematic structure diagram of an image generating device according to another embodiment of the present disclosure. In some embodiments, as shown in FIG. 5, the image generating device may include a second display element 1013 and a polarizer 1014. The second display element 1013 emits non-linearly polarized light. The polarizer 1014 converts the non-linearly polarized light emitted from the second display element 1013 into the required linearly polarized light to obtain the first projection light.

In some embodiments, the first polarization conversion element 104 and the second polarization conversion element 106 are ¼ wave plates, respectively.

The ¼ wave plate can convert incident linearly polarized light into circularly polarized light, or convert incident circularly polarized light into linearly polarized light. The optical path of the head-up display using a ¼ wave plate as the polarization conversion element in FIG. 2 is specifically as follows. The P-polarized light emitted from the image generating device 101 is transmitted through the polarization beam splitting layer 103 and is incident on the first polarization conversion element 104. The P-polarized light transmitted through the first polarization conversion element 104 is converted into left-handed (or right-handed) circularly polarized light, and becomes right-handed (or left-handed) circularly polarized light after being reflected by the first reflective element 105. After being transmitted through the first polarization conversion element 104 again, it is converted into S-polarized light. Then the light is incident on the polarization beam splitting layer 103 for the second time.

The S-polarized light reflected by the polarization beam splitting layer 103 is incident on the second polarization conversion element 106, is transmitted through the second polarization conversion element 106, and is converted into left-handed (or right-handed) circularly polarized light. It becomes right-handed (or left-handed) circularly polarized light after being reflected by the second reflective element 107. The circularly polarized light is transmitted through the second polarization conversion element 106 again and converted into P-polarized light, then incident on the polarization beam splitting layer 103 for a third time, and then incident on the reflective element 102 after being transmitted through the polarization beam splitting layer 103. During the whole process, the light reaches the surfaces of the PBS (polarizing beam splitter) 3 times, and the multiple reflections inside the PBS can effectively increase the spatial density of the beam and reduce the system volume. It can be seen that in the present disclosure, the polarization beam splitting layer selectively transmits or reflects linearly polarized light beams in a plurality of optical paths, and does not function to split a light beam into two linearly polarized light beams with propagation directions perpendicular to each other.

Similarly, the optical path of the head-up display using a ¼ wave plate as the polarization conversion element in FIG. 3 is specifically as follows. The S-polarized light emitted from the image generating device 101 is reflected by the polarization beam splitting layer 103 and incident on the first polarization conversion element 104. The S-polarized light is transmitted through the first polarization conversion element 104 and converted into left-handed (or right-handed) circularly polarized light. After being reflected by the first reflective element 105, it becomes right-handed (or left-handed) circularly polarized light. Then the circularly polarized light is transmitted through the first polarization conversion element 104 and converted into P-polarized light again, and is incident on the polarization beam splitting layer 103 for the second time.

The P-polarized light transmitted through the polarization beam splitting layer 103 is incident on the second polarization conversion element 106, and is converted into left-handed (or right-handed) circularly polarized light after being transmitted through the second polarization conversion element 106, and becomes right-handed (or left-handed) circularly polarized light after being reflected by the second reflective element 107. Then the circularly polarized light is transmitted through the second polarization conversion element 106 and converted into S-polarized light, incident on the polarization beam splitting layer 103 for the third time, and then incident on the reflective element 102 after being reflected by the polarization beam splitting layer 103.

Optionally, the reflective element 102 is a windshield of a vehicle. In this embodiment, the observer can observe an individual clear projection in front of the vehicle. The angle at which the P-polarized light is incident on the windshield is related to the reflectivity. When the reflectivity is low, the reflectivity can be increased by coating the windshield with a reflective film.

The present disclosure also provides a vehicle including the head-up display provided in any one of the above-mentioned embodiments.

The flowcharts and block diagrams in the drawings illustrate the architecture, functionality, and operation of possible implementations of systems, methods and computer program products according to various embodiments of the present disclosure. In this regard, each block in the flowchart or block diagram may represent a module, a program segment, or a part of code containing one or more executable instructions for implementing a specified logical function. It should also be noted that in some alternative implementations, the functions noted in the blocks may also occur in a different order than those marked in the drawings. For example, two successively connected blocks may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs the specified function or operation, or it can be implemented with a combination of dedicated hardware and computer instructions.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A head-up display, comprising:
an image generating device; and
an optical module comprising a first optical component, a second optical component, and a third optical component,
wherein the first optical component is on a light emitting side of the image generating device,
wherein the image generating device is configured to emit a first projection light to the first optical component,
wherein the first projection light comprises linearly polarized light,
wherein the second optical component is configured to receive the first projection light reflected or transmitted by the first optical component to change a polarization direction of the first projection light to obtain a second projection light, and to reflect the second projection light back to the first optical component, and
wherein the third optical component is configured to receive the second projection light reflected or transmitted by the first optical component to change a polarization direction of the second projection light to obtain a third projection light, and to reflect the third projection light back to the first optical component.

2. The head-up display according to claim 1, wherein the first optical component comprises a polarization beam splitting element, and the polarization beam splitting element is configured to selectively transmit or reflect two linearly polarized light beams whose polarization directions are perpendicular to each other.

3. The head-up display according to claim 1,
wherein the first projection light comprises P-polarized light, the second projection light comprises S-polarized light, and the third projection light comprises P-polarized light,
wherein the first optical component is configured to transmit the first projection light to the second optical component, to reflect the second projection light to the third optical component, and to transmit the third projection light.

4. The head-up display according to claim 1,
wherein the first projection light comprises S-polarized light, the second projection light comprises P-polarized light, and the third projection light comprises S-polarized light, and
wherein the first optical component is configured to reflect the first projection light to the second optical component, to transmit the second projection light to the third optical component, and to reflect the third projection light.

5. The head-up display according to claim 3,
wherein the second optical component comprises a first polarization conversion element and a first reflective element, and
wherein the third optical component comprises a second polarization conversion element and a second reflective element.

6. The head-up display according to claim 5, wherein at least one of the first reflective element or the second reflective element comprises a concave mirror.

7. The head-up display according to claim 6, wherein one of the first reflective element or the second reflective element comprises a flat mirror.

8. The head-up display according to claim 1,
wherein the image generating device comprises a first display element and a half-wave plate;
wherein the first display element is configured to emit linearly polarized light; and
wherein the half-wave plate is configured to change a polarization direction of the linearly polarized light emitted from the first display element to obtain the first projection light.

9. The head-up display according to claim 1,
wherein the image generating device comprises a second display element and a polarizer,
wherein the second display element is configured to emit non-linearly polarized light, and
wherein the polarizer is configured to convert the non-linearly polarized light emitted from the second display element into linearly polarized light to obtain the first projection light.

10. The head-up display according to claim 6, wherein the first polarization conversion element and the second polarization conversion element are ¼ wave plates, respectively.

11. The head-up display according to claim 1,
wherein the optical module further comprises a fourth optical component, and
wherein the fourth optical component is configured to receive and reflect the third projection light.

12. The head-up display according to claim 11, wherein the fourth optical component comprises a windshield of a vehicle.

13. A vehicle comprising the head-up display according to claim 1.

14. The vehicle according to claim 13,
wherein the first optical component comprises a polarization beam splitting element, and
wherein the polarization beam splitting element is configured to selectively transmit or reflect two linearly polarized light beams whose polarization directions are perpendicular to each other.

15. The vehicle according to claim 13,
wherein the first projection light comprises P-polarized light, the second projection light comprises S-polarized light, and the third projection light comprises P-polarized light, and
wherein the first optical component is configured to transmit the first projection light to the second optical component, to reflect the second projection light to the third optical component, and to transmit the third projection light.

16. The vehicle according to claim 13,
wherein the first projection light comprises S-polarized light, the second projection light comprises P-polarized light, and the third projection light comprises S-polarized light, and
wherein the first optical component is configured to reflect the first projection light to the second optical component, to transmit the second projection light to the third optical component, and to reflect the third projection light.

17. The vehicle according to claim 13,
wherein the image generating device comprises a first display element and a half-wave plate,
wherein the first display element is configured to emit linearly polarized light, and
wherein the half-wave plate is configured to change a polarization direction of the linearly polarized light emitted from the first display element to obtain the first projection light.

18. The vehicle according to claim 13,
wherein the image generating device comprises a second display element and a polarizer,
wherein the second display element is configured to emit non-linearly polarized light, and
wherein the polarizer is configured to convert the non-linearly polarized light emitted from the second display element into linearly polarized light to obtain the first projection light.

19. The vehicle according to claim 13,
wherein the optical module further comprises a fourth optical component, and
wherein the fourth optical component is configured to receive and reflect the third projection light.

20. The head-up display according to claim 4,
wherein the second optical component comprises a first polarization conversion element and a first reflective element,
wherein the third optical component comprises a second polarization conversion element and a second reflective element,
wherein at least one of the first reflective element or the second reflective element comprises a concave mirror, and
wherein one of the first reflective element or the second reflective element is a flat mirror.
